(19) United States
(12) Patent Application Publication
(10) Pub. No.: US 2018/0009570 A1
(43) Pub. Date: Jan. 11, 2018

(54) BOTTLE CAP ACCESSORY

(71) Applicant: UFAB Moms, LLC, Peachfree City, GA (US)

(72) Inventors: Annette Michelle Marshall, Fayetteville, GA (US); Mellissa Dianne Craig, Fayetteville, GA (US)

(21) Appl. No.: 15/711,398

(22) Filed: Sep. 21, 2017

(51) Int. Cl. B65D 23/14; B67B 5/03

(52) U.S. Cl. CPC B65D 23/14; B67B 5/03

(57) ABSTRACT

A bottle cap accessory includes a tubular body having a first end opposite a second end. The tubular body defines an opening at the second end. The bottle cap accessory includes a top surface integrally affixed to the first end and a character affixed to the top surface. The bottle cap accessory also includes an annular lip extending radially outward from the second end. The opening is adapted to receive at least a portion of a bottle cap.

### TECHNICAL FIELD

The present disclosure is directed to accessories for container enclosures and, more particularly, to an accessory that fits over a bottle cap of disposable beverage bottles.

### BACKGROUND

One person's beverage bottles, such as disposable water bottles, soda bottles, or the like, are often indistinguishable from another's bottle of the same beverage. This may be particularly true at large gatherings, where people are drinking beverages supplied from the same case. If one were to place their bottle down, it may be difficult for that person to recall exactly which opened bottle is theirs, which may lead to excess waste as one may retrieve a new, unopened bottle, rather than risk drinking from another person's bottle. As another example, this problem may arise in households where multiple people are consuming bottled beverages, but may not finish their bottle in one sitting. This results in multiple, half-consumed, unlabeled beverage bottles ending up as waste. There is a need for one to be able to distinguish their beverage bottle from another's.

While wine charms have provided a solution for identifying one's wine glass among others', there is a need for a reusable, adaptable solution for similarly identifying one's disposable beverage containers.

### SUMMARY

The disclosed apparatuses allow a user to mark or label their beverage bottle by selecting an article of manufacture having a particular design and affixing the article on the cap of the beverage bottle. These articles may also function as novelty items or toys. The article may optionally be comprised of a gripping material, such as rubber, plastic, or other resilient material. The article may be reusable. Further, the article may be shaped so that it forms a snug connection with a variety of sizes or shapes of beverage bottle caps.

In an aspect, this disclosure is directed to a bottle cap accessory. The bottle cap accessory may include a tubular body having a first end opposite a second end. The tubular body may define an opening at the second end. The bottle cap accessory may include a top surface integrally affixed to the first end. The bottle cap accessory may include a character affixed to the top surface and an annular lip extending radially outward from the second end. The opening may be adapted to receive at least a portion of a bottle cap.

In another aspect, this disclosure is directed to a bottle cap accessory. The bottle cap accessory may include a tubular body having a closed first end opposite an open second end. The tubular body may define a chamber. The bottle cap accessory may include a character affixed to the closed first end and an annular lip extending radially outward from the open second end. The chamber may be adapted to receive at least a portion of a bottle cap.

In another aspect, this disclosure is directed to a system. The system may include a bottle cap accessory and a bottle cap removably inserted into the bottle cap accessory. The system may also include bottle having a bottle opening, the bottle cap removably affixed to the bottle opening. The system may also include a character integrally affixed to the bottle cap accessory.

### BRIEF DESCRIPTION OF THE DRAWINGS

FIG. 1 is an illustration of a bottle cap accessory affixed to a closed beverage bottle.

FIG. 2 is a first perspective view of a bottle cap accessory.

FIG. 3 is a second view of a bottle cap accessory.

FIG. 4 is a front view of a bottle cap accessory.

FIG. 5 is a back view of a bottle cap accessory.

FIG. 6 is a top view of a bottle cap accessory.

FIG. 7 is a bottom view of a bottle cap accessory.

FIG. 8 is a side view of a bottle cap accessory, the opposite side being a mirror image thereof.

### DETAILED DESCRIPTION

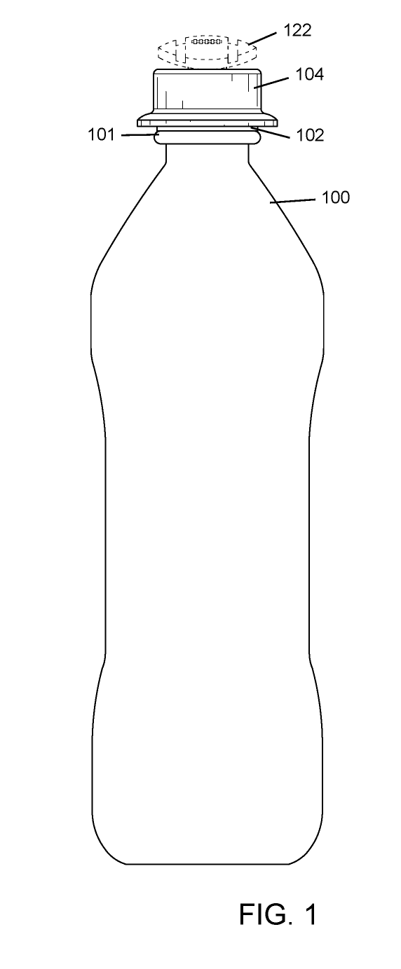

FIG. 1 illustrates an exemplary bottle 100 have a bottle cap 102 and an accessory 104 affixed to bottle cap 102. Bottle 100 may be a disposable container in which beverages or other liquids are sold. Additionally or alternatively, bottle 100 may be a reusable container. The shape and material of bottle 100 may vary. For example, bottle 100 may be a plastic, 20-ounce, such as those in which soda, water, or other beverages are sold. Additionally or alternatively, bottle 100 may be made of glass, paper, or other material. Bottle 100 may be sized for individual use, or it may be a larger container, such as a growler or one-gallon jug. Bottle 100 may have a bottle opening 101 through which contents may be inserted into and/or removed from bottle 100. To prevent contamination of the contents, and to prevent contents from spilling out, bottle 100 may include a bottle cap 102. Bottle cap 102 may seal bottle 100. Bottle cap 102 may be resealable. For example, bottle cap 102 may be threaded complementary to a mouth 106 of bottle 100, such that bottle cap 102 may be screwed on/unscrewed from bottle 100. Additionally or alternatively, bottle cap 102 may be a snap-on cap. Like bottle 100, bottle cap 102 may vary in size, shape, and material.

Accessory 104 may be designed to affix onto bottle cap 102. For example, one or more materials of which accessory 104 may be formed may have resiliency and/or friction coefficients sufficient to engage with bottle cap 102. For example, accessory 104 may comprise silicone or other gripping material that may engage with bottle cap 102 to cause resistance in moving bottle cap 102 relative to accessory 104 when such components are in physical contact. Additionally or alternatively, accessory 104 may be sized so that bottle cap 102 may snugly fit within accessory 104. This may be facilitated by using somewhat flexible material that can be expanded to fit around a portion of bottle cap 102 but then retain a close fit around bottle cap 102. Accessory 104 may comprise rubber, silicone, or other plastic material.

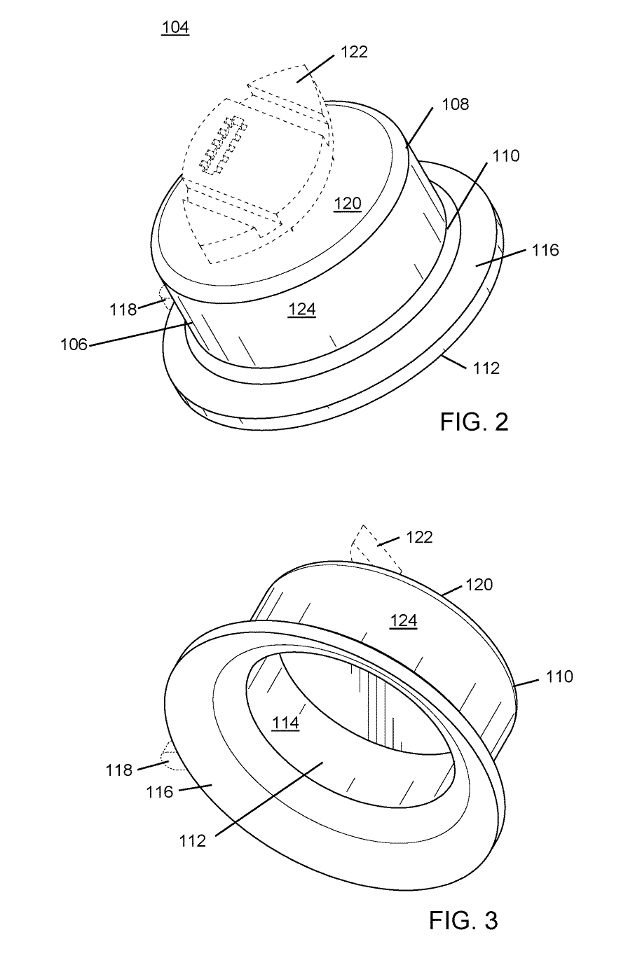

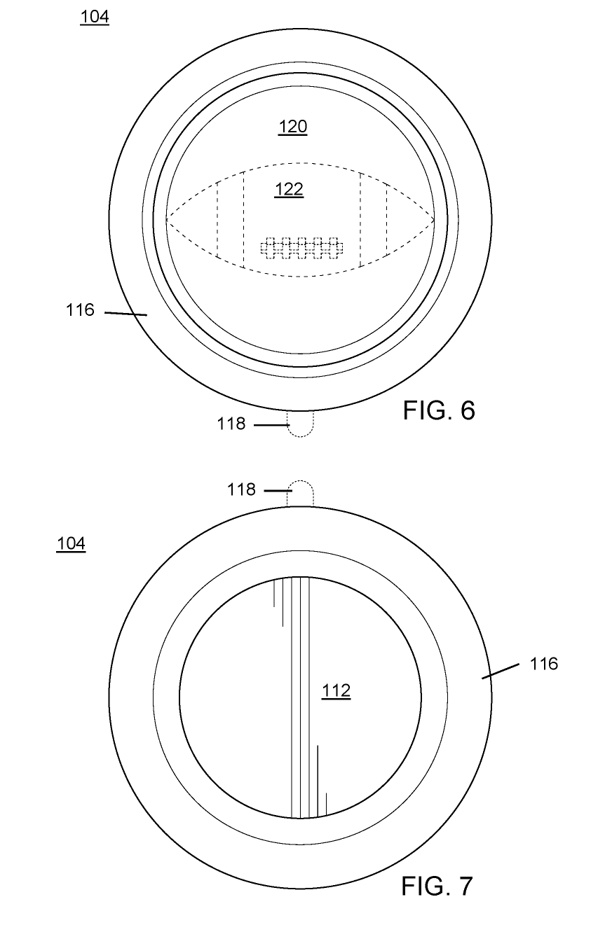

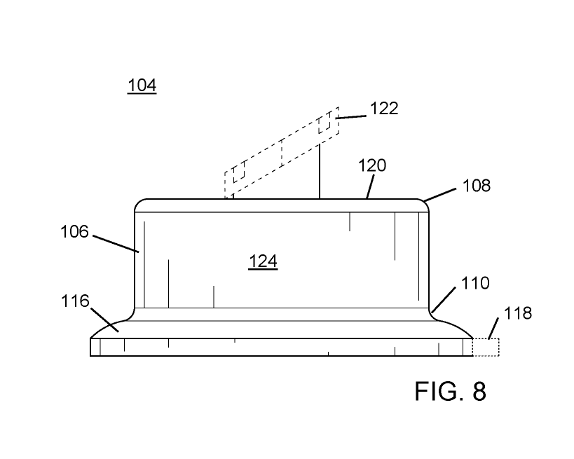

Accessory 104 is shown in FIGS. 2-8.

FIGS. 2 and 3 illustrate perspective views of accessory 104. Accessory 104 may be an integrated component shaped to fit on at least a portion of the outer surface of bottle cap 102. Accessory 104 may include a tubular body 106 having a first end 108 and a second end 110. Accessory 104 may include a top surface 120 integrally affixed to first end 108. Second end 110 may form an aperture, or opening 112, at the bottom of accessory 104. Opening 112 may be adapted to receive and engage at least a portion of bottle cap 102 so that accessory 104 may operate to affix to bottle 100 and be used to identify bottle 100.

As shown in FIG. 3, tubular body 106 may comprise an inner surface 114. Inner surface 114 may be adapted to receive bottle cap 102, such as when bottle cap 102 is installed on bottle 100. For example, inner surface 114 may be substantially cylindrical. Optionally, inner surface 114 may be textured or threaded to engage with bottle cap 102. A radius of inner surface 114 may be selected to accommodate and engage bottle cap 102. For example, opening 112 may be adapted to receive at least a portion of bottle cap 102. The radii of bottle caps 102 on disposable plastic bottles, for example, may fall within a certain range. The inner radius may be selected to facilitate use of accessory 104 with a variety of bottle caps 102. For example, the inner radius may be (1) between approximately 0.95 and 1.30 inches; (2) between approximately 1.00 and 1.25 inches; (3) between approximately 1.10 and 1.20 inches; or (4) 1.15 inches.

As further shown, accessory 104 may include an annular lip 116 extending radially outward from second end 110. Annular lip 116, in conjunction with opening 112, may function as a suction cup. Thus, annular lip 116 may include a tab 118 that may be lifted to release a suction formed by accessory 104 on a smooth surface. For example, bottle button accessory 104 may be suctioned to the surface of a refrigerator, so that accessory 104 is within reach for use when a bottle is taken from the fridge, and otherwise may serve as a decoration when not in use.

As shown in FIGS. 2 and 3, at first end 108 of tubular body 106, accessory 104 may include a top surface 120. Top surface 120 may function to seal first end 108 of tubular body 106. Top surface 120 may be planar, as shown in the FIGs. Additionally or alternatively, a shape of top surface 120 may vary.

Tubular body 106 may comprise an outer surface 124. As shown in FIG. 3, outer surface 124 may be cylindrical; however, the shape of outer surface 124 is not limited to such. A height of tubular body 106, measured as a distance between top surface 120 and annular lip 116, may be (1) between approximately 0.5 and 1.0 inches; (2) between approximately 0.6 and 0.8 inches; or (3) 0.75 inches.

Accessory 104 may have one or more characters 122 integrally or removably affixed to one or more outer surfaces, such as top surface 120. For example, character 122 may snap onto top surface 120. For example, character 122 may include one or more letters, numerals, symbols, designs, patterns, or the like. For example, characters 122 on accessory 104 in the FIGs. is a football icon. Additionally or alternatively, accessory 104 and/or its character 122 may vary in color, texture, material, or other design, such that accessory 104 may be used to identify bottle 100 onto which it is affixed from other, otherwise similar bottles 100.

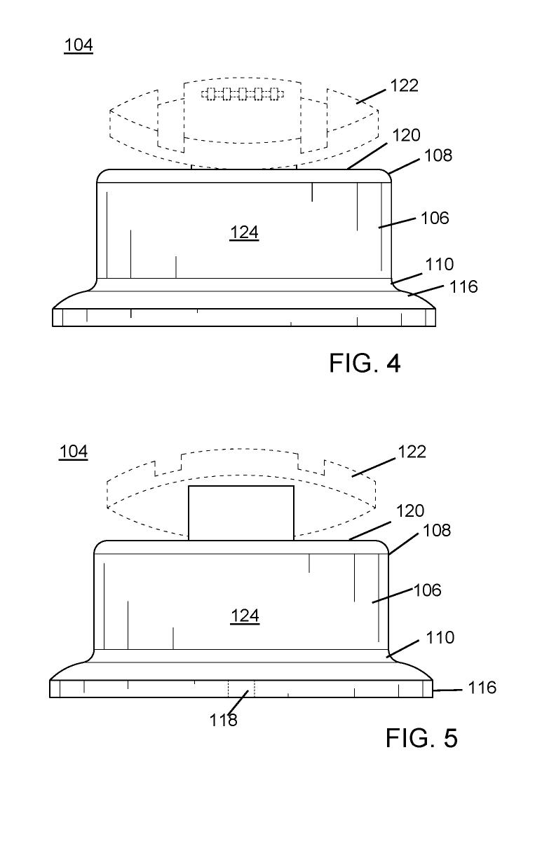

As shown in the figures, such as FIGS. 4, 5, and 8, character 122 may extend distally from top surface 120. Measured from top surface 102, a height of character 122 may be (1) between approximately 0.1 and 1.0 inches; (2) 0.5 and 0.8 inches; or (3) 0.72 inches.

The following aspects describe different optional implementations.

1. A bottle cap accessory comprising: a tubular body having a first end opposite a second end, the tubular body defining an opening at the second end; a top surface integrally affixed to the first end; a character affixed to the top surface; and an annular lip extending radially outward from the second end, wherein the opening is adapted to receive at least a portion of a bottle cap.

2. A bottle cap accessory comprising: a tubular body having a closed first end opposite an open second end, the tubular body defining a chamber; a character affixed to the closed first end; and an annular lip extending radially outward from the open second end, wherein the chamber is adapted to receive at least a portion of a bottle cap.

3. A system comprising: a bottle cap accessory including a character integrally affixed to the bottle cap accessory; a bottle cap removably inserted into the bottle cap accessory; and a bottle having a bottle opening, the bottle cap removably affixed to the bottle opening.

4. The system of aspect 3, the bottle cap accessory comprising: a tubular body having a closed first end opposite an open second end, the tubular body defining a chamber; a character affixed to the closed first end; and an annular lip extending radially outward from the open second end.

5. The system of aspect 4, wherein the chamber is adapted to receive at least a portion of the bottle cap.

6. The system of aspect 4 or 5, wherein the chamber is engaged with the bottle cap.

7. The system of aspect 3, the bottle cap accessory comprising: a tubular body having a first end opposite a second end, the tubular body defining an opening at the second end; a top surface integrally affixed to the first end; a character affixed to the top surface; and an annular lip extending radially outward from the second end.

8. The system of aspect 7, wherein the opening is adapted to receive at least a portion of a bottle cap.

9. The system of aspect 7 or 8, wherein a tubular body having a first end opposite a second end, wherein the opening is engaged with the bottle cap.

10. The bottle cap accessory of aspect 1 or 2, wherein an inner surface of the tubular body is cylindrical.

11. The bottle cap accessory of aspect 1, 2, or 10, wherein an inner surface radius of the inner surface is approximately between approximately 0.95 and 1.30 inches.

12. The bottle cap accessory of aspect 1, 2, 10, or 11, wherein the radius is between 1.00 and 1.25 inches.

13. The bottle cap accessory of any one of aspects 1, 2, or 10-12, wherein the radius is between 1.10 and 1.20 inches.

14. The bottle cap accessory of any one of aspects 1, 2, or 10-13, wherein the radius is 1.15 inches.

15. The bottle cap accessory of any one of aspects 1, 2, or 10-14, wherein an outer radius of the tubular body is between approximately 1.6 and 2.0 inches.

16. The bottle cap accessory of aspect 15 wherein the outer radius is between 1.70 and 1.90 inches.

17. The bottle cap accessory of aspect 15 or 16 wherein the outer radius is between 1.8 and 1.85 inches.

18. The bottle cap accessory of aspect 15, 16, or 17, wherein the outer radius is 1.82 inches.

19. The bottle cap accessory of any one of aspects 1, 2, or 10-18, wherein a height of the tubular body is approximately 0.50 to 1.0 inches.

20. The bottle cap accessory of aspect 19, wherein the height is approximately 0.6 to 0.8 inches.

21. The bottle cap accessory of any one of aspects 1, 2, or 10-20, wherein the character extends distally from the top surface such that the character has a character height between approximately 0.1 to 1.0 inches.

22. The bottle cap accessory of aspect 21, wherein the character height is between approximately 0.5 and 0.8 inches.

23. The bottle cap accessory of aspect 21 or 22, wherein the character height is 0.72 inches.

24. The bottle cap accessory of any one of aspects 1, 2, or 10-23, wherein the annular lip comprises a component of a suction cup.

25. The bottle cap accessory of any one of aspects 1, 2, or 10-24, wherein the character comprises a letter or numeral.

26. The bottle cap accessory of any one of aspects 1, 2, or 10-15, wherein the character comprises an icon.

27. The bottle cap accessory of any one of aspects 1, 2, or 10-26, wherein the character is integrally affixed to the top surface.

28. The system of aspect 3-9, wherein the bottle cap accessory comprises any one of aspects 1, 2, or 10-27.

While bottle cap accessories have been described in connection with the various embodiments of the various figures, it is to be understood that other similar embodiments can be used or modifications and additions can be made to the described embodiments for implementing bottle cap accessories without deviating therefrom. For example, one skilled in the art will recognize that bottle cap accessories as described in the present application may be designed with differing dimensions, and with differing characters. Therefore, bottle cap accessories should not be limited to any single embodiment, but rather should be construed in breadth and scope in accordance with this description and the appended aspects.

1. A bottle cap accessory comprising:
a tubular body having a first end opposite a second end, the tubular body defining an opening at the second end;
a top surface integrally affixed to the first end;
a character affixed to the top surface; and
an annular lip extending radially outward from the second end,
wherein the opening is adapted to receive at least a portion of a bottle cap.

2. The bottle cap accessory of claim 1, wherein an inner surface of the tubular body is cylindrical.

3. The bottle cap accessory of claim 1, wherein an inner surface radius of the inner surface is between approximately 0.95 and 1.30 inches.

4. The bottle cap accessory of claim 1, wherein an outer radius of the tubular body is between approximately 1.6 and 2.0 inches.

5. The bottle cap accessory of claim 1, wherein the annular lip comprises a component of a suction cup.

6. The bottle cap accessory of claim 1, wherein the character extends distally from the top surface.

7. The bottle cap accessory of claim 1, wherein the character has a character height measured from the top surface between approximately 0.1 to 1.0 inches.

8. The bottle cap accessory of claim 1, wherein the character comprises an icon.

9. The bottle cap accessory of claim 1, wherein the character comprises a letter or numeral.

10. A system comprising:
a bottle cap accessory including a character integrally affixed to the bottle cap accessory;
a bottle cap removably inserted into the bottle cap accessory; and
a bottle having a bottle opening, the bottle cap removably affixed to the bottle opening.

11. The system of claim 10, the bottle cap accessory comprising:
a tubular body having a closed first end opposite an open second end, the tubular body defining a chamber;
a character affixed to the closed first end; and
an annular lip extending radially outward from the open second end.

12. The system of claim 11, wherein the chamber is adapted to receive at least a portion of the bottle cap.

13. The system of claim 11, wherein the chamber is engaged with the bottle cap.

14. The system of claim 10 , the bottle cap accessory comprising:
a tubular body having a first end opposite a second end, the tubular body defining an opening at the second end;
a top surface integrally affixed to the first end;
a character affixed to the top surface; and
an annular lip extending radially outward from the second end.

15. The system of claim 14, wherein the opening is adapted to receive at least a portion of a bottle cap.

16. The system of claim 14, wherein a tubular body having a first end opposite a second end, wherein the opening is engaged with the bottle cap.

17. The system of claim 10, wherein the annular lip comprises a component of a suction cup.

18. The system of claim 10, wherein the character extends distally from the top surface.

19. The system of claim 18, wherein the character has a character height measured from the top surface between approximately 0.1 to 1.0 inches.

20. The system of claim 1, wherein the character comprises at least one of an icon, a letter, or a numeral.
